(19) United States
(12) Patent Application Publication
(10) Pub. No.: US 2025/0356356 A1
(43) Pub. Date: Nov. 20, 2025

(54) SYSTEM AND METHOD FOR IDENTIFYING DATA CONNECTIONS

(71) Applicant: Actimize Ltd., Ra'anana (IL)

(72) Inventors: Rohan DINDE, Pune (IN); Nikhil GATTANI, Pune (IN)

(73) Assignee: Actimize Ltd., Ra'anana (IL)

(21) Appl. No.: 18/664,885

(22) Filed: May 15, 2024

(51) Int. Cl. G06Q 20/40

(52) U.S. Cl. CPC G06Q 20/4016

(57) ABSTRACT

A system and method for identifying data connections may include a computing device; a memory; and a processor, the processor configured to: generate a connection analysis prompt from one or more data items of a first dataset for identifying one or more data items of a second dataset; and apply said connection analysis prompt to a machine learning model to produce an output from the machine learning model of whether said one or more data items of the first dataset are connected to said one or more data items of the second dataset; and when said one or more data items of the first dataset have one or more connections to said one or more data items of a second dataset, to produce an alert.

### TECHNICAL FIELD OF THE INVENTION

The present invention relates generally to the detection of data connections, more specifically to the identification of data connections in one or more customer datasets.

### BACKGROUND OF THE INVENTION

Fraud prevention and anti-money laundering software is commonly used to generate customer alerts about suspicious transactions or non-transaction activities. To identify an alert, analysts of banks or other financial institutions may be required to examine large amounts of data and manually identify suspicious activities of customers. One of the ways to identify financial crime, may be to review link analysis graphs of customer data which have been part of previous alerts generated either for the same person/business entity or for a different person/business entity.

However, manual identification of matches between specific pieces of customer data and previously identified fraudulent data, e.g. in form of data pieces which are known to have been leaked in a data breach, can require a lot of analyst time.

Presently, analysts may dedicate several hours to investigate entity linkages for a single fraud alert. For a detailed investigation of a fraud alert, analysts may be required to review discrete connections for a large number of data pieces. Identification of a particular piece of customer data and manually scanning it across existing datasets can further delay such an investigation. Therefore, the chances of objectively assessing and successfully identifying a match of customer data in two different alerts can be drastically reduced in cases in which a manual fraud detection is used. Simply automating such a solution may not be feasible.

Thus, there is a need for a solution that allows for identifying data connections between different datasets, e.g. to identify links between a first customer dataset and a second dataset such as dataset which was found to have been used in fraudulent activities.

### SUMMARY OF THE INVENTION

Embodiments of the invention may improve the technology of data analysis, by or example intelligently creating input to an artificial intelligence model, e.g. generating a connection analysis prompt, in order to find links between datasets which are otherwise difficult for computerized processes to identify. Improvements and advantages of embodiments of the invention may include identifying data connections between different datasets, e.g. between customer datasets and third party datasets, such as datasets which have been involved in fraudulent activities or in money laundering activities. Embodiments may more efficiently identify data connections between different datasets.

In one aspect, the present invention allows automatically assessing relationships between data items of two or more datasets. For example datasets for a customer which belong to different sources, e.g. a dataset of a transaction database and a dataset of an address database.

One embodiment may include a method of identifying data connections, the method including: generating a connection analysis prompt from one or more data items of a first dataset for identifying one or more data items of a second dataset; applying the connection analysis prompt to a machine learning model to produce an output from the machine learning model of whether the one or more data items of the first dataset are connected to the one or more data items of the second dataset; and when the one or more data items of the first dataset have one or more connections to the one or more data items of a second dataset, producing an alert.

In one embodiment, the one or more data items of the first dataset include a network of customer data items which are linked to a customer dataset.

In one embodiment, applying the connection analysis prompt includes identifying data items within the one or more data items of a first dataset which are terminal data items and determining whether the terminal data items are similar to the one or more data items of the second dataset using machine learning.

One embodiment includes updating the first dataset based on the connections between the one or more data items of the first dataset and the one or more data items of the second dataset.

In one embodiment, the machine learning model is a large language model.

In one embodiment, the one or more data items of the first dataset are extracted from an interaction transcript.

In one embodiment, the generation of the connection analysis prompt for identifying connections is generated from previously generated connection analysis prompts for identifying connections of the customer.

In one embodiment, the connection analysis prompt includes the one or more data items of a first dataset and one or more operators for querying a database comprising the one or more data items of the second dataset.

One embodiment includes updating the first dataset when the one or more data items have been linked to the one or more data items of the second dataset.

In one embodiment, the connections are connections between the one or more data items of the first dataset and data items of a fraud dataset and the connection analysis prompt is applied to a machine learning model to analyze whether the one or more data items of the first dataset have connections to the one or more data items of the fraud dataset.

One embodiment may include a system for identifying data connections, the system including: a computing device; a memory; and a processor, the processor configured to: generate a connection analysis prompt from one or more data items of a first dataset for identifying one or more data items of a second dataset; and apply the connection analysis prompt to a machine learning model to produce an output from the machine learning model of whether the one or more data items of the first dataset are connected to the one or more data items of the second dataset; and when the one or more data items of the first dataset have one or more connections to the one or more data items of a second dataset, to produce an alert.

One embodiment may include a method for automatically identifying fraud in data connections, the method including: generating a fraud detection prompt from a plurality of customer data items for identifying links of the plurality of customer data items to one or more fraud action data items; and applying the fraud detection prompt to a machine learning model to produce an output from the machine learning model of whether the plurality customer data items is linked to the one or more fraud action data items; and when the plurality of customer data items is linked to the one or more fraud action data items, creating a fraud notification.

One embodiment may include a method for automatically identifying money laundering in data connections, the method including: generating a money laundering detection prompt from a plurality of customer data items for identifying links of the plurality of customer data items to one or more money laundering data items; and applying the money laundering detection prompt to a machine learning model to produce an output from the machine learning model of whether the plurality customer data items is linked to the one or more money laundering data items; and when the plurality of customer data items is linked to the one or more money laundering data items, creating a money laundering notification.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is a schematic drawing of a system for identifying data connections, according to some embodiments of the invention.

FIG. 3 depicts a flowchart of methods of identifying data connections, according to some embodiments of the present invention.

FIG. 4 is an illustration of an exemplary link analysis graph and user interface which can be used to represent and initiate the identification of data connections, according to some embodiments of the present invention.

FIG. 5A is an illustration of an exemplary user interface which may be used to initiate the identification of data connections, according to some embodiments of the invention.

FIG. 5B is an illustration of an exemplary user interface which may be used to initiate the identification of data connections, according to some embodiments of the invention.

FIG. 6 shows a schematic drawing of operations of an interaction service in the identification of data connections, according to some embodiments of the present invention.

FIG. 7 is an illustration of operations in the generation of a connection analysis prompt which may be executed by an interaction service to identify data connections to one or more data items of a second dataset, according to some embodiments of the present invention.

FIG. 8 illustrates a generation of a connection analysis prompt from one or more data items of a first dataset, e.g. including the translation of a dataset, e.g. a response of a customer into json format, according to some embodiments of the present invention.

FIG. 9 illustrates three use cases in an identification of data connections, according to some embodiments of the present invention.

FIG. 10 illustrates example operations to initiate an identification of data connections, according to some embodiments of the present invention.

FIG. 11 illustrates an example output of a method of identifying data connections, according to some embodiments of the present invention.

FIG. 12 illustrates example operations in the generation of an output of a method of identifying data connections, according to some embodiments of the present invention.

FIG. 13 illustrates operations of an interaction service in the generation of a connection analysis prompt from customer input, e.g. a customer dataset, for the identification of data connections, according to some embodiments of the present invention.

FIG. 14 is a schematic illustration of data flow in a system for identifying data connections, according to some embodiments of the present invention.

FIG. 15 is a schematic illustration of data flow in a system for identifying data connections, according to some embodiments of the present invention.

FIG. 16 is a schematic illustration of operations performed to update previously identified data connections when a new dataset is retrieved, according to some embodiments of the present invention.

FIG. 17 is a schematic drawing of a system for identifying data connections in a customer facing user interface, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “contact center” may refer to a centralized office used for receiving or transmitting a large volume of enquiries, communications, or interactions. The enquiries, communications, or interactions may include telephone calls, emails, message chats, SMS (short message service) messages, etc. A contact center may, for example, be operated by a company to administer incoming product or service support or information enquiries from customers/consumers. The company may be a contact-center-as-a-service (CCaaS) company.

As used herein, “call center” may refer to a contact center that primarily handles telephone calls rather than other types of enquiries, communications, or interactions. Any reference to a contact center herein should be taken to be applicable to a call center, and vice versa.

As used herein, “interaction” may refer to a communication between two or more people (e.g., in the context of a contact center, an agent and a customer), typically via devices such as computers, customer devices, agent devices, etc., and may include, for example, voice telephone calls, conference calls, video recordings, face-to-face interactions (e.g., as recorded by a microphone or video camera), emails, web chats, SMS messages, etc. An interaction may be recorded to generate an “interaction recording”. An interaction or interaction recording may also refer to the data which is distributed, transferred or stored in a computer system recording the interaction (for example the data stream distributed to an agent), and the data representing the interaction, including for example voice or video recordings, data items describing the interaction or the parties, a text-based transcript of the interaction, etc. Interactions as described herein may be “computer-based interactions”, e.g., one or more voice telephone calls, conference calls, video recordings/streams of an interaction, face-to-face interactions (or recordings thereof), emails, web chats, SMS messages, etc. Interactions may be computer-based if, for example, the interaction has associated data or metadata items stored or processed on a computer, the interaction is tracked or facilitated by a server, the interaction is recorded on a computer, data is extracted from the interaction, etc. Some computer-based interactions may take place via the internet, such as some emails and web chats, whereas some computer-based interactions may take place via other networks, such as some telephone calls and SMS messages. An interaction may take place using text data, e.g., email, web chat, SMS, etc., or an interaction may not be text-based, e.g., voice telephone calls. Non-text-based interactions may be converted into text-based interaction recordings (e.g., using automatic speech recognition). Interaction data and Interaction recordings may be produced, transferred, received, etc., asynchronously. For example, one or more interactions may be assigned to an agent at the same time or at different times. An agent, e.g. an agent of a contact center may handle one or more interactions, e.g. with customers, concurrently—at the same time—or one interaction at a time.

As used herein, “user” may refer, for example, to a data analyst, who is reviewing data items of datasets, e.g. of transactions of customers. A data analyst may interact with a user interface of an application, e.g. service 708, and can submit data items, e.g. a first dataset of customer for which they would like to identify data connections, e.g. data connections to another customer, e.g. via data items of a dataset of a second customer.

As used herein, “customer” may refer to a customer submitting datasets, e.g. datasets of transactions, e.g. money transfers to another customer. Datasets may include data items of 0, 1, 2, 3 or more data items. A data item maybe an attribute of a customer, e.g. a customer identifier, a tax identifier of a customer, a customer address.

A “data connection” may be a link or association of data items of a customer between different datasets, e.g. between a first dataset stored in database X and a second dataset stored in database Y. A link or data connection may be a similar or identical data item which is present in two different datasets, e.g. a tax identification number 12345 of customer A may be present in dataset X and dataset Y and may allow connecting datasets X and Y of customer A.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms. In a supervised ML approach, input sample data may include data which is labeled, for example, in the present application, the input sample data may include a transcript of an interaction and a label indicating whether or not the interaction was satisfactory. In an unsupervised ML approach, the input sample data may not include any labels, for example, in the present application, the input sample data may include interaction transcripts only.

A “connection analysis prompt” may be a prompt, query or input, e.g. in json or format such as a plain text format, which is submitted as input to a machine learning model, e.g. a LLM, so that the machine learning model may produce output identifying data connections.

A “link analysis graph” may be a visual representation, or a data representation analogous to such a visual representation, of one or more data items of a customer dataset. A link analysis graph may also include alerts, e.g. warnings when a data item was found to be present in another dataset, e.g. a dataset which is known to have been used in a criminal act, e.g. fraud or money laundering.

A “dataset” may include a set of data items, e.g. details such as transaction details of a customer. Datasets may be stored in a database. Some data items, e.g. identifiers such as tax identification numbers may allow identifying a customer and may allow linking customer activity over several datasets.

ML models may, for example, include Large Language Models (LLM) such as Generative Pre-Trained Transformer (GPT), Bidirectional Encoder Representations from Transformers (BERT), Pathways Language Model (PaLM) and the like, (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

For the distribution of interaction data to agents, e.g. the distribution of calls to agents based on estimated future interaction events generated by a prediction prompt, interaction data or an interaction recording may be separated into words that are analyzed using an LSTM model. For example, data items such as interaction metadata items present in an interaction or sentences of an interaction, such as an interaction transcript, may be divided into one or more parts which may be used in the generation of a prediction prompt.

In practice, an LLM or NN, or NN learning, can be simulated by one or more computing nodes or cores, such as generic central processing units (CPUs, e.g., as embodied in personal computers) or graphics processing units (GPUs such as provided by Nvidia Corporation), which can be connected by a data network. A NN can be modelled as an abstract mathematical object and translated physically to CPU or GPU as for example a sequence of matrix operations where entries in the matrix represent neurons (e.g., artificial neurons connected by edges or links) and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

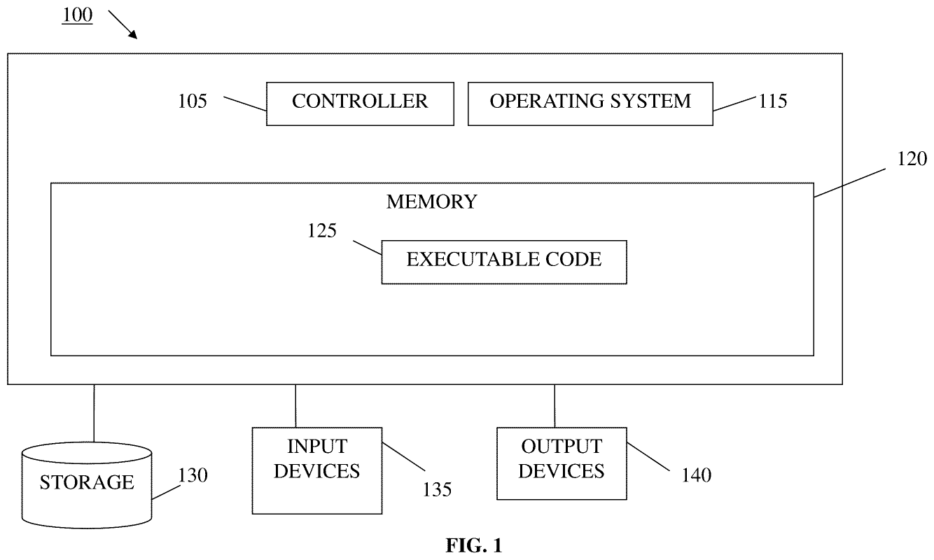

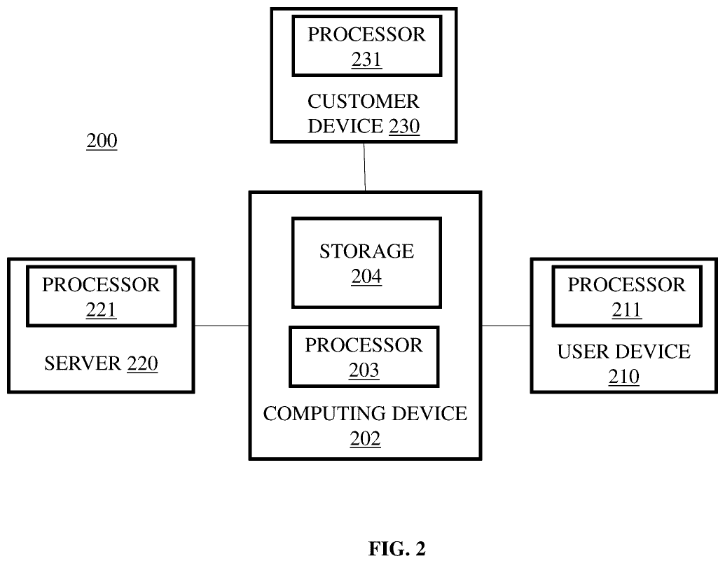

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment and other devices and modules discussed herein, e.g. interaction service 708, and modules in FIGS. 2, 3, 4, 5A, 5B, 6, 7, 8, 9, 9, 10, 11, 12, 13, 14, 15, 16, 17, may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

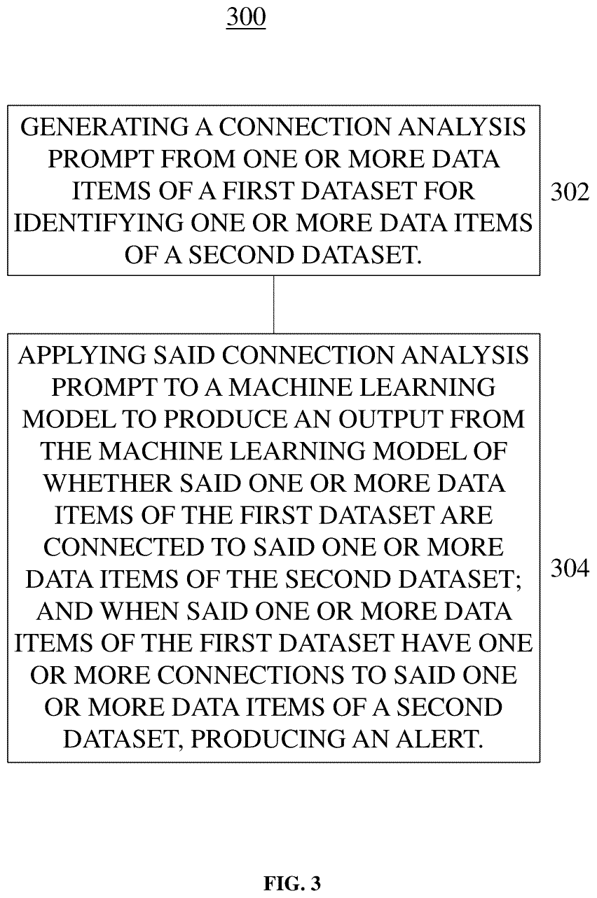

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 3 or other figures, or other methods, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 2 is a schematic drawing of a system 200, according to some embodiments of the invention. System 200 may include a computing device 202 including a processor 203 and storage 204. Computing device 202 may be connected to an user device 210 that includes processor 211. Computing device 202 may be connected to a server 220 including processor 221. Computing device 202 may be connected to a customer device 230 including processor 231. Server 220 and user device 210 may provide computing device 202 with interaction recordings. Alternatively, interaction recordings may be stored in storage 204 of computing device 202.

Computing devices 100, 202, 210, 220 and 230 may be servers, personal computers, desktop computers, mobile computers, laptop computers, and notebook computers or any other suitable device such as a cellular telephone, personal digital assistant (PDA), video game console, etc., and may include wired or wireless connections or modems. Computing devices 100, 202, 210, 220 and 230 may include one or more input devices, for receiving input from a user (e.g., via a pointing device, click-wheel or mouse, keys, touch screen, recorder/microphone, or other input components). Computers 100, 202, 210, 220 and 230 may include one or more output devices (e.g., a monitor, screen, or speaker) for displaying or conveying data to a user.

Any computing devices of FIGS. 1 and 2 (e.g., 100, 202, 210, 220 and 230), or their constituent parts, may be configured to carry out any of the methods of the present invention. Any computing devices of FIGS. 1 and 2, or their constituent parts, may include an interaction service 708, Large Language Model (LLM) 606, or another engine or module, which may be configured to perform some or all of the methods of the present invention. Systems and methods of the present invention may be incorporated into or form part of a larger platform or a system/ecosystem, such as agent management platforms. The platform, system, or ecosystem may be executed using the computing devices of FIGS. 1 and 2, or their constituent parts. A processor such as processor 203 of computing device 202 processor 211 of device 210, and/or processor 221 of computing device 220 may be configured to generate a connection analysis prompt from one or more data items of a first dataset for identifying one or more data items of a second dataset. For example, datasets may include datasets which include personal information of a customer, e.g. data items such as postal addresses, banking information, or tax identification or any form of data related to transactions or used in online banking. For example, a connection analysis prompt may be used to produce an output as to whether or not a first dataset is connected to a dataset which has been involved in fraudulent activities and the connection analysis prompt is a fraud detection prompt which may be generated from a plurality of customer data items for identifying links of the plurality of customer data items to one or more fraud action data items. For example, a connection analysis prompt may be used to produce an output as to whether or not a first dataset is connected to a dataset which has been involved in money laundering activities and a connection analysis prompt is a money laundering detection prompt which may be generated from a plurality of customer data items for identifying links of the plurality of customer data items to one or more money laundering data items, e.g. a name and an address of a customer present in a first dataset and a second dataset. A processor such as processor 203 of computing device 202 processor 211 of device 210, and/or processor 221 of computing device 220 may be configured to apply the connection analysis prompt to a machine learning model to produce an output from the machine learning model of whether or not one or more data items of the first dataset are connected to one or more data items of the second dataset. For example, a first dataset of customer A may include personal banking information, e.g. dataset X, of a customer A. Dataset X may be used in the generation of a connection analysis prompt to identify whether or not data items of dataset X may be present in a dataset Y of bank Z. For example, when one or more data items of the first dataset have one or more connections to one or more data items of a second dataset, a processor is configured to produce an alert. For example, when one or more data items of the first dataset do not have one or more connections to one or more data items of a second dataset, a processor is configured not to produce an alert.

FIG. 3 shows a flowchart of an example method 300 of for identifying data connections, e.g. data connections between a customer dataset such as name, postal address, bank details of a customer and datasets of a database such as a transactions database which includes planned or previously executed transactions, according to embodiments of the present invention. In an example, method 300 may be used to automatically identify fraud activities or money laundering activities in data connections. As an example for a practical use, data connections may be connections between one or more data items of a first dataset and data items of a fraud dataset and a connection analysis prompt may be applied to a machine learning model to analyze whether or not one or more data items of a first dataset have connections to one or more data items of a fraud dataset. As an example for a practical use, data connections may be connections between one or more data items of a first dataset and data items of a money laundering dataset and a connection analysis prompt may be applied to a machine learning model to analyze whether or not one or more data items of a first dataset have connections to one or more data items of a money laundering dataset. Datasets of a customer and datasets of a database may be received from storage of a computing device, e.g. user device 210, customer device 230, or computing device 202. The system displayed in FIG. 2 and the method shown in FIG. 3 may refer to the generation of a connection analysis prompt used to produce an output from the machine learning model of whether or not one or more data items of a first dataset are connected to one or more data items of a second dataset based on comparison of datasets or data items therein which have been received from a user device, e.g. 210, a database, e.g. server 220, or customer device 230, however, the system and the method may also be used to generate a connection analysis prompt when executed on a server or user device. According to some embodiments, some or all of the steps of the method are performed (e.g., fully or partially) by one or more of the computational components, for example, those shown in FIGS. 1 and 2.

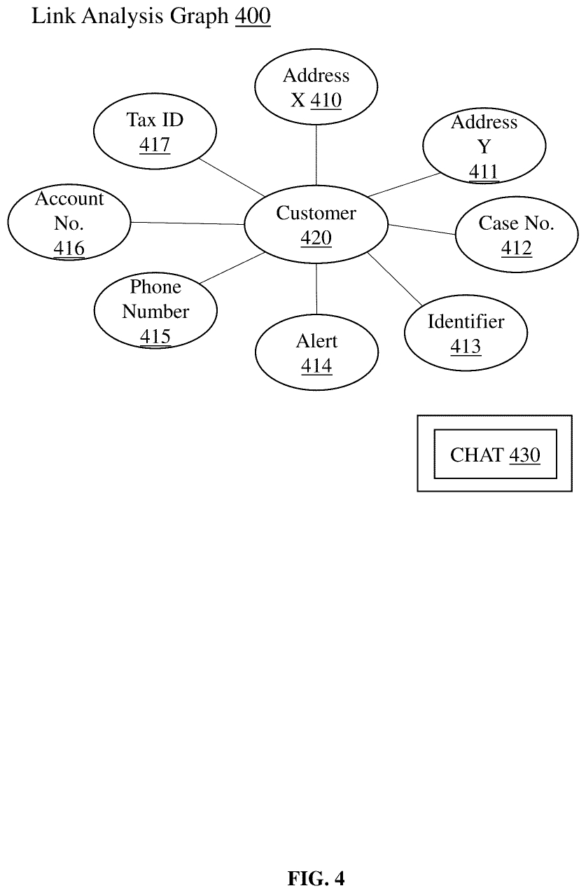

In operation 302, a connection analysis prompt from one or more data items of a first dataset for identifying one or more data items of a second dataset may be generated. One or more data items of a first dataset may include a number of customer data items which are linked to a customer dataset. For example, a number of customer data items which are linked to a customer dataset is shown in FIG. 4 and includes data items of a customer 420 such as account number 416, case number 412 and identifier 413. A connection analysis prompt may include one or more data items of a customer dataset, e.g. customer name, address, banking details, date of birth. Data items may include numeric values, string values, dates, etc. Data items of a dataset may be included in a connection analysis prompt to allow comparing data items within a customer dataset with datasets of which have been previously recorded, e.g. previous transaction receipts, or datasets which might be recorded in the future, e.g. upcoming transactions and transaction requests. In some cases, a connection analysis prompt may include all data items of a customer dataset. In some cases, a connection analysis prompt may include a selection of data items of a customer dataset. For example, in some instances, e.g. to protect individual identities, only transaction numbers but no names or addresses may be used to generate a connection analysis prompt. A connection analysis prompt may be, for example, a fraud detection prompt which includes a plurality of customer data items for identifying links of a plurality of data items to one or more fraud action data items, e.g. data items which may be known as being used in fraudulent activities such as money laundering.

Data items of datasets may be extracted from interaction transcripts. For example, an interaction transcript generated in an interaction of a contact center between an agent and a customer may include information on a customer such as customer name, address, bank details, telephone number. Data items of a customer present in an interaction transcript may form a dataset and can be used in the generation of a connection analysis prompt.

In operation 304, a connection analysis prompt may be applied or input to a machine learning model to produce an output from the machine learning model of whether one or more data items of the first dataset are connected to one or more data items of a second dataset. For example, when one or more data items of a first dataset have one or more connections to one or more data items of a second dataset, an alert may be produced. For example, when one or more data items of a first dataset have no connections to one or more data items of a second dataset, no alert may be produced. Application of a connection analysis prompt to a machine learning model to produce an output may include submitting a first and a second dataset to a ML model to compare values of data items, e.g. to assess whether one or more values of data items of a first data set are present in a second dataset. For example, Dataset A and dataset B may include a data item labelled “customer reference”, which in turn may have a value (e.g. 987-A). By application of the connection analysis prompt to a machine learning model, a machine learning model may identify whether a customer reference, e.g. customer reference 1234 is present in dataset A and in dataset B. In case that a customer reference 1234 is present in dataset A and in dataset B, a connection between dataset A and dataset B is established and, as an output, an alert is produced. In case that a customer reference 1234 is only present in dataset A or in dataset B, no connection between dataset A and dataset B is established and, as an output, no alert is produced. For instance, application of a connection analysis prompt such as a fraud detection prompt to a machine learning model may produce an output from a machine learning model of whether a plurality customer data items is linked to one or more fraud action data items.

As an example for a practical use, a connection analysis prompt, such as a fraud detection prompt for the detection of fraud by identifying a connection between a first dataset and data items of a fraud dataset or a money laundering detection prompt for the detection of money laundering by identifying a connection between a first dataset and data items of a money laundering dataset, may be applied to a machine learning model to produce an output from the machine learning model of whether or not the plurality customer data items is linked to one or more fraud action data items or money laundering data items. When the plurality of customer data items is linked to one or more fraud action data items or money laundering data items, a fraud notification or money laundering notification may be created. An example fraud notification may read: “The bank details of customer X are present in fraudulent database Y and customer X is involved in fraudulent activity”. An example money laundering notification may read: “The address details of customer Z are present in money laundering database Y and customer Z is involved in money laundering activity”. When the plurality of customer data items is not linked to one or more fraud action data items or one or more money laundering data items, no fraud notification or money laundering notification may be created.

A machine learning model used in the application of a connection analysis prompt may be, for example, a large language model such as ChatGPT by Open AI Inc. or OpenAI by Azure Inc.

Applying a connection analysis prompt may include identifying data items within one or more data items of a first dataset which are terminal data items and determining whether terminal data items are similar to one or more data items of the second dataset using machine learning. Terminal data items may be data items which are linked to a customer but which are not further connected or linked to another data item, e.g. a data item of another dataset. For example for customer X, a phone number which has not been shared with anyone else may be a terminal data item, whereas a case identifier for customer support by company A may be present in a customer dataset and in a dataset of company A. Data items of datasets may be similar, if they share the same content, e.g. the same tax ID 612-23-3 may be present in dataset A and dataset B, or data items of datasets may be similar if they contain the same content among other information, e.g. a phone number may include a phone prefix in one dataset and no phone prefix in a second dataset.

A connection analysis prompt may include one or more data items of a first dataset and one or more operators for querying a database including one or more data items of the second dataset. For example, an operator may be a logical operator such as “and” or “or” and a connection analysis prompt of a first dataset may be used to identify a connection of a first dataset “and a second dataset via a first data item “and” a second data item or may be used to identify a connection of a first dataset and a second dataset via a first data item “or” a second data item.

Previously generated connection analysis prompts may be used in the generation of a new connection analysis prompt. For example, a connection analysis prompt generated previously at time X for customer C may be re-used and may be re-applied at later time Y to a ML model periodically, e.g. every week, every month or every year.

A dataset, e.g. first dataset, may be updated based on identified connections between one or more data items of the first dataset and one or more data items of the second dataset. For example, in case that a second dataset includes the same tax identifier as the first dataset but also includes additional data items, e.g. a second address of a customer, a first dataset may be amended to include a second address of a customer as a data item. In this way, it can be identified whether a fraudulent activity, e.g. money laundering, may have occurred based on previously recorded activities of a customer, e.g. a customer A may have used a credit card number in several occasions and all data items of each dataset used in each occasion may be connected to customer A. For example, a first dataset may be updated when one or more data items of a first dataset have been linked to one or more data items of a second dataset and data items of the second dataset may be included in a first dataset. For example, a first dataset may not be updated when one or more data items of a first dataset have not been linked to one or more data items of a second dataset and data items of the second dataset may not be included in a first dataset.

Operations 302 and 304 may be performed for one dataset at a time, but may also be performed for several datasets at the same time, e.g. concurrently in parallel. Initiation of operations 302 and 304 may occur periodically, e.g. identifying data connections may proceed every hour, every date, every month or may occur when a fraudulent dataset is detected, e.g. a dataset has been found being part in a data breach.

FIG. 4 is an illustration of an exemplary link analysis graph and user interface which can be used to represent and initiate the identification of data connections.

A link analysis graph 400 may be a visual representation of data items 410-417 of a customer dataset 420. In some embodiments, systems manipulate a data representation of such a graph which is not actually displayed or visualized as a graph. Data items may include, for example, a first postal address 410 (e.g. 133 Fifth Avenue, New York City, US), a second postal address 411 (260 Main Street, London, GB), a case number 412 (e.g. customer case no. 256-24), an identification document 413 (e.g. passport number 56789), an alert 414 (e.g. a previous alert related to a data or security breach), a phone number 415 (+1 1234567), an account number 416 (e.g. 123456), or a tax number 417 (e.g. 2024-1234-12).

A user interface may include a link analysis graph 400 to display data connections of a customer, e.g. customer dataset 420 and a chat button 430, e.g. for requesting the identification of data connections.

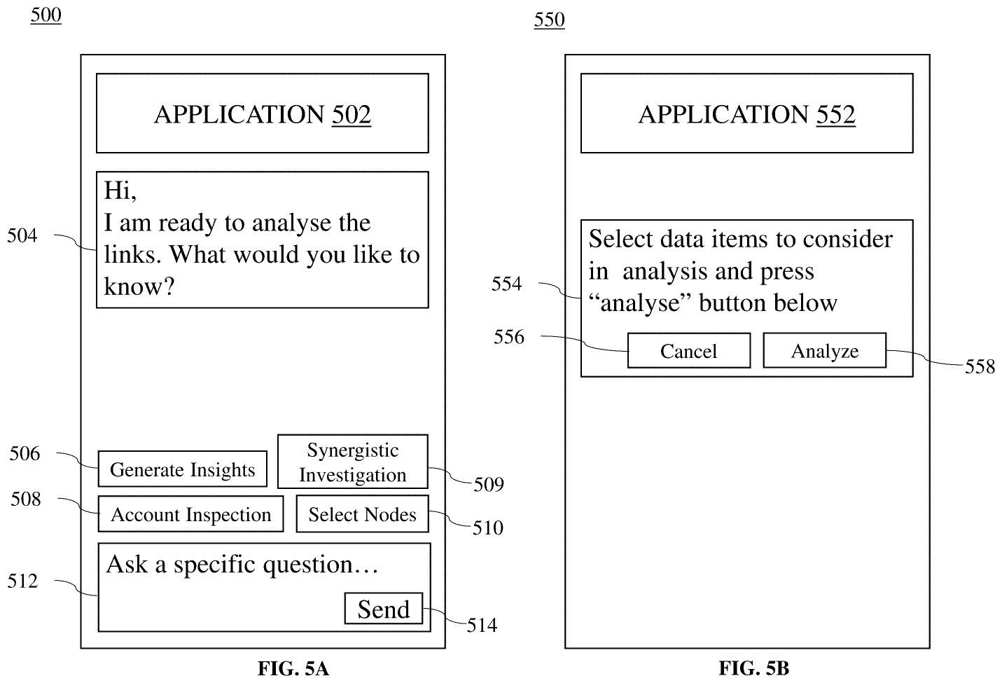

FIG. 5A may be an illustration of an exemplary user interface 500 which may be used to initiate an identification of data connections.

User interface 500 may include an application name 502 and a message 504 which indicates that the system is ready to receive a query to identify data connections.

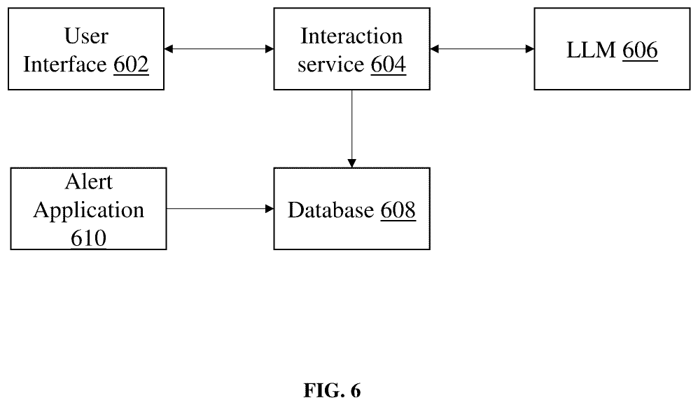

User interface 500 may allow a user, e.g. a customer, to submit datasets to an interaction application 500. Datasets may include one or more data items, e.g. data items shown in FIG. 4 such as address 410, or phone number 415, and may be used in the generation of a connection analysis prompt. A connection analysis prompt may be in json format and may be applied to a machine learning model, e.g. LLM 606 shown in FIG. 6.

User interface 500 may include an option “generate insights” 506 which may allow generating a summary of a dataset of a customer which can include all data items of a dataset, for example generate insights may provide a summary of data items A, B and C which are connected to customer X. Data items of a dataset may be sent to an LLM model, which can analyze data items. An LLM model may provide an output in form of a summary which may include data items of a customer, e.g. customer 420 using customer device 230.

User interface 500 may include an option “account inspection” 508 which allows reviewing details of data items of a link analysis graph, e.g. graph 400. For example, account inspection may allow reviewing address details such as street name of a data item address of customer Y.

An LLM model may be queried with prompts to retrieve information on a customer dataset as an output. Further an LLM model may be configured to memorize the flow of queries and contextual questions can be asked to analyze a link analysis graph.

An LLM model may be ChatGPT by OpenAI Inc., which can generate an output in text form based on provided input. However, any other LLM model may be used in the system and method. For example Amazon Web Services has “Bedrock service” which can give access to various LLM models and Azure also has “OpenAI service” which gives access to a range of LLM models. An LLM model may have the following responsibilities: Producing an output, e.g. in text form based on a prompt, e.g. a connection analysis prompt, retrieved from an application or a user interface. Producing an output, e.g. in text form based on a prompt, which can be used by an interaction service, e.g. interaction service 604 shown in FIG. 6, to identify related alerts, e.g. alerts which have previously recorded for data items or datasets, and providing output via a user interface, e.g. with a user, e.g. an analyst using computing device 210. Selected data items of datasets which are submitted to an LLM may be removed or encrypted, e.g. to allow exercising data security regulations or to comply with data protection rules.

User interface 500 may include an option identifying data connections, also referred to herein as “synergistic investigation” 509 which allows identifying data connections of data items of a first dataset to data items of a second dataset. For example, identifying data connections 509 may allow identifying data items of a dataset A for customer X which are not linked to other data items within dataset A and may allow applying a prompt including such data items to a ML model, e.g. a LLM model to identify connections of data items of a first dataset and data items of a second dataset to produce an output, e.g. in form of an alert when one or more data items of a second dataset are connected to a first dataset.

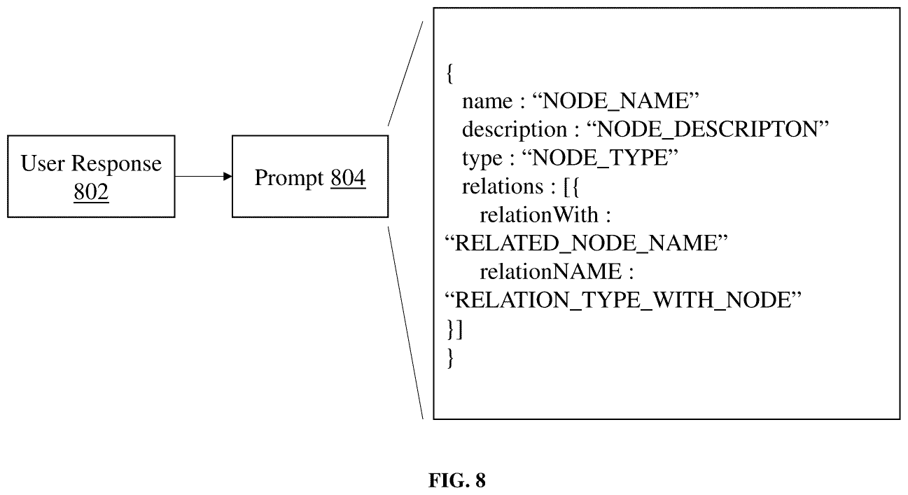

User interface 500 may include an option “select nodes” 510 which allows specifying data items of a dataset of a customer which can be included in a connection analysis prompt, e.g. prompt 804 shown in FIG. 8.

User interface 500 may include an option “ask a specific question” 512 which can allow retrieving a specific output from datasets. For example, if a data item of a dataset includes an account number ‘123456’ in a dataset, e.g. a dataset represented by a generated summary of a link analysis graph, a user can type in the chat window of option 512 “Who owns ‘123456’?” and sending the question (operation 514) to an LLM model. The solution can then understand that the number ‘123456’ in the prompt is an account mentioned previously in the link analysis graph and hence an LLM model can provide insights on a customer based on a customer account number. Further, for example, when a user asks, “Please elaborate further on 123456”, an LLM Model may provide further details on a customer, e.g. in form of an output of data items or alerts.

FIG. 5B may be an illustration of an exemplary user interface 550 which may be used to initiate the identification of data connections.

User interface 550 may allow a user, e.g. a customer, to submit datasets to an interaction application 552. An analysis 554 of a dataset may be initiated by pressing “analyze” 558 or cancelled by pressing “cancel” 556. Datasets may include one or more data items, e.g. data items shown in a link analysis graph 400 such as account number 416, or tax identifier 417, and may be used in the generation of a connection analysis prompt. A connection analysis prompt may be in json format and may be applied to a machine learning model, e.g. LLM model 606 shown in FIG. 6.

FIG. 6 shows a schematic drawing of operations of an interaction service in the identification of data connections.

A user interface, e.g. user interface 602, may send datasets or data items of datasets to interaction service 604. Interaction service 604 may generate an connection analysis prompt from one or more data items of a dataset. Interaction service 604 may apply the connection analysis prompt to a machine learning model, e.g. ML model 606. A ML model may produce an output of whether or not one or more data items of a first dataset are connected to one or more data items of the second dataset. For example, when one or more data items of the first dataset have one or more connections to one or more data items of a second dataset, an alert may be produced. When one or more data items of the first dataset do not have one or more connections to one or more data items of a second dataset, no alert may be produced.

This allows automatically assessing relationships between data items of two or more datasets. Output may be received by interaction service 604 and may be displayed to a customer, e.g. via user interface 602. Interaction service 604 may query datasets in previously received databases 608 for existing alerts which may have a connection with one or more data items of a first dataset.

A background service 610 may update database 608 in case that a new alert has been produced, e.g. when one or more data items of a first dataset have one or more connections to one or more data items of a second dataset.

For example, a dataset can include a data item such as a phone number “-813565074” in a link analysis graph of customer C; executing option 509 may allow investigating whether the phone number has previously been used in financial fraud actions of customers of bank B with transaction datasets X, Y and Z. A connection analysis prompt may include data items of dataset of customer C and data items of datasets of customers X, Y and Z of bank B. In case that data item phone number “813565074” is present in a data item of datasets X, Y or Z, a ML model may produce an output in form of an alert, e.g. an alert that dataset X of bank B is connected to the dataset of customer C.

Accordingly, the identification of data connections allows identifying data items of a dataset which are not linked to data items within the same dataset and allows identifying connections to other datasets, e.g. when a data item of a dataset is present in a second dataset or present in a previously generated alert, e.g. stored in an alert database. Updating an analysis graph, e.g. graph 400, with identified connections may allow expanding an link analysis graph and allows identifying hidden connections between different datasets, e.g. of databases for which previous alerts have been recorded. Identification of data connections may allow increasing the probability of identifying customer datasets which have been linked to fraud or other suspicious activities such as money laundering and may allow identifying mule accounts of fraudsters which share email addresses, phone numbers or any other data entities.

The identification of data connections may be restricted to a specific period in time, e.g. to reduce the amount of processed databases. For example, a connection analysis prompt may specify that data items of a first dataset may be identified in data items of a second dataset which have been added within the last month. This allows reducing the amount of processed data in the identification of data connections to recent connections which have occurred over the last month.

A user, e.g. an analyst retrieving a produced output of a LLM, may retrieve an updated link analysis graph which shows data connections to suspicious datasets and allows an analyst to directly take action in response to an alert, e.g. to suspend or close a customer account which is linked to a dataset including a suspicious activity. An analyst may further retrieve multiple alerts for datasets which can include connections to a suspicious data item in a single data connection identification and may not be required to conduct additional searches based on a single, manually identified suspicious activity. Thus, the present solution allows streamlining the process of fraud identification and customer data protection by reducing the time spent in the identification of fraudulent activities.

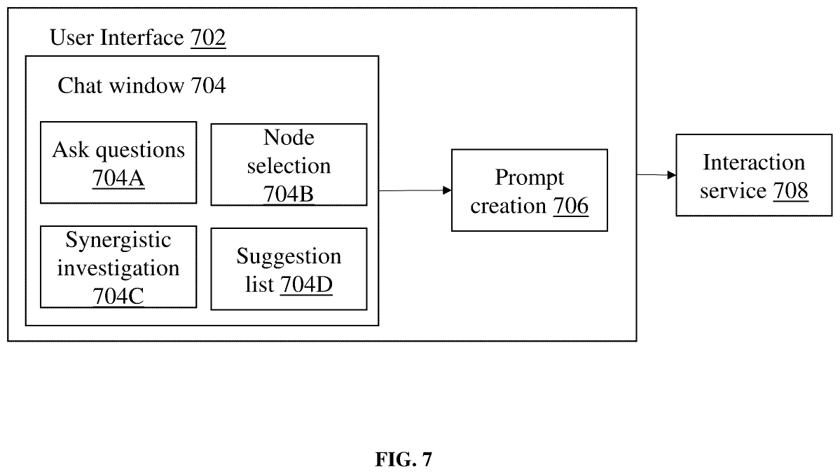

FIG. 7 is an illustration of operations in the generation of a connection analysis prompt which may be executed by an interaction service to identify data connections to one or more data items of a second dataset. User interface 702 may include a chat window 704 to provide input, e.g. in form of datasets of data items therein for the generation of an analysis prompt 706. Input may be retrieved, e.g. by the provision of a question 704A, e.g. identify data connections for dataset X of database A with all datasets present in fraud database B, by the selection of data items within a dataset 704B, e.g. selection of data item phone number in the generation of a connection analysis prompt, by carrying out a synergistic investigation 704C to identify all data items in a second dataset based on data items which are present in one or more data items of a first dataset or a suggestion list 704D. Retrieved input may be used in the generation of a connection analysis prompt, e.g. generated by an interaction service 708.

FIG. 8 illustrates the generation of a connection analysis prompt from one or more data items of a first dataset, e.g. including the translation of a dataset, e.g. a response of a customer into json format.

For example, a prompt 804 may be generated from user input, e.g. user response 802, and may include two parts: data items of datasets used in the generation of an output, e.g. data items of a customer dataset of customer X such as tax identifier, name and address; and instructions for an LLM to be executed a connection analysis prompt.

In the generation of a connection analysis prompt, datasets and data items therein, or summaries of datasets may be converted into a data format which can be executed by a LLM to produce an output, e.g. in the form of an alert.

For example, a dataset of a customer, e.g. as represented by a link analysis graph 400, may be retrieved and may be converted into an LLM understandable format in from of a connection analysis prompt.

An example data analysis prompt is shown below; other forms and formats may be used:

```
{
  name : “NODE_NAME”
  description : “NODE_DESCRIPTON”
  type : “NODE_TYPE”
  relations : [{
    relationWith : “RELATED_NODE_NAME”
    relationNAME : “RELATION_TYPE_WITH_NODE”
}]
}
```

Thus, a data analysis prompt may include known connections of a dataset, e.g. connections to data items within a dataset or to data items of external datasets. For example, a prompt may include data items of a first dataset, e.g. telephone number, names, addresses, bank details, and data items of a second dataset, e.g. tax identifier, names addresses in a data format that can be executed by an LLM, e.g. json format.

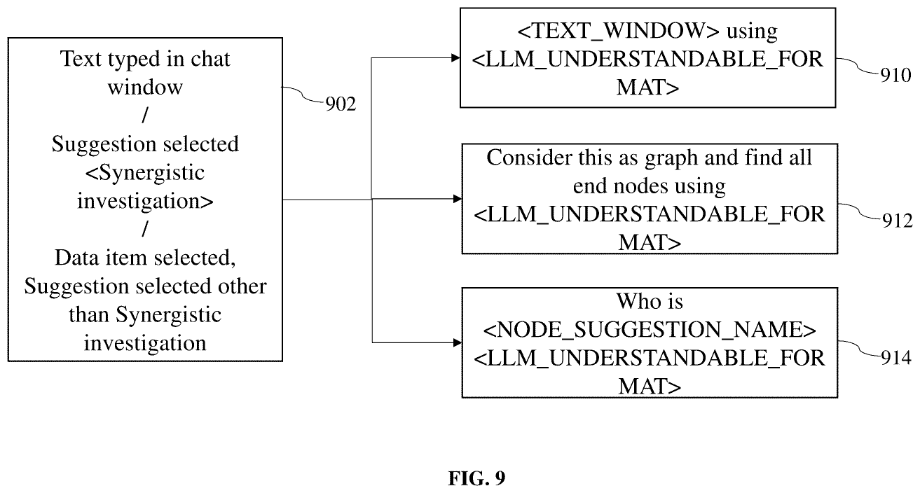

FIG. 9 illustrates three use cases 902 in the identification of data connections.

Instructions 910, 912 or 914 may be sent to a machine learning model to generate an output in form of a summary or an alert.

Instructions 910, 912 or 914 may be respective to functionality which a user is trying to access.

Instructions 910, 912 or 914 can be amended based on results provided by LLM model. Below diagram shows sample basic instruction for three different functionalities:

For example, input 910 for generating a connection analysis prompt includes text in a chat window which includes data items, e.g. of a dataset. Text in a chat window may be transformed into a connection analysis prompt, e.g. using the command <TEXT_WINDOW> using <LLM_UNDERSTANDABLE_FORMAT>.

For example, input 912 for generating a connection analysis prompt can include identifying data connections. Identifying data connections may be transformed into a connection analysis prompt, e.g. using the command “consider data items of a dataset of a link analysis graph and identify all data items using <LLM_UNDERSTANDABLE_FORMAT>.

For example, input 914 for generating a connection analysis prompt includes a selected data item or suggestion. A selected data item or suggestion may be used in the generation of a connection analysis prompt via the command “Who is <NODE_SUGGESTION_NAME> using <LLM_UNDERSTANDABLE_FORMAT>”

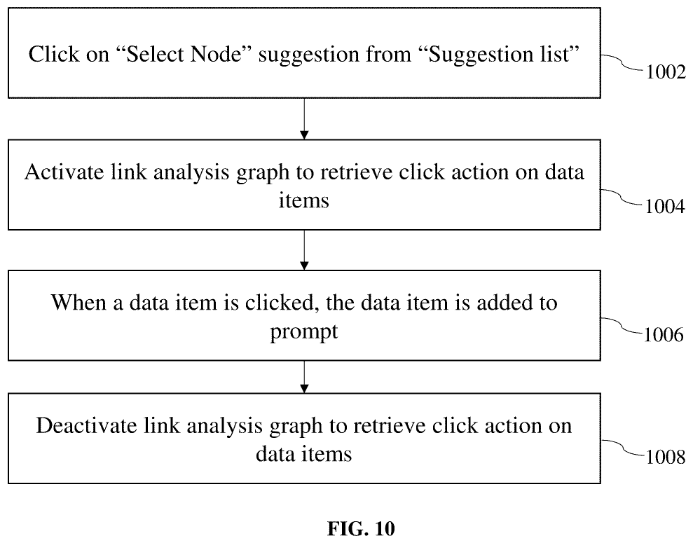

FIG. 10 illustrates example operations to initiate an identification of data connections.

Data items of a dataset for the generation of a connection analysis prompt may be provided, for example via a selection of data items by a user, e.g. an analyst. A user may submit data items, e.g. by clicking on a select node suggestion from the suggestion list, e.g. select nodes 510 shown in FIG. 5 (operation 1002). A link analysis graph, e.g. graph 400 shown in FIG. 4, may be activated, e.g. by retrieving a click action on a data item of the graph, e.g. data item 410 or 411 (operation 1004). Once a data item of a link analysis graph is selected, it may be included in a connection analysis prompt (operation 1006). A selection of data items may be stopped, e.g. by deactivation of a link analysis graph (operation 1008). Selected data items may then be used in the generation of a connection analysis prompt.

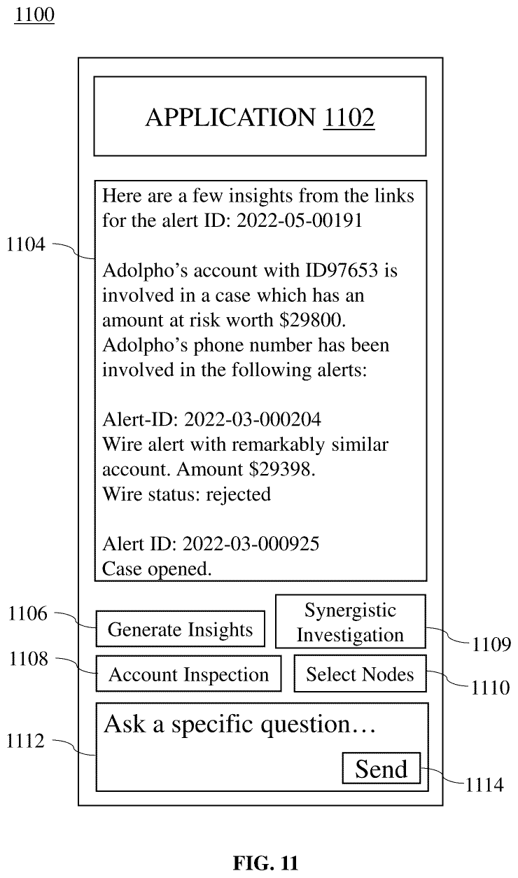

FIG. 11 illustrates an example output of a method of identifying data connections.

User interface 1100 of application 1102 may include output 1104, button 1106 for the generation of insights, button 1108 for account inspection, button 1109 for initiating synergistic investigation, button 1110 for the selection of data items and text field 1112 and send button 1114 for providing input in text form.

Output 1104 may include data items of datasets and alerts for the data items. For example, an alert may include the following details: Alert-ID: 2022-03-000204 Wire alert with remarkably similar account. Amount $29398. Wire status: rejected.

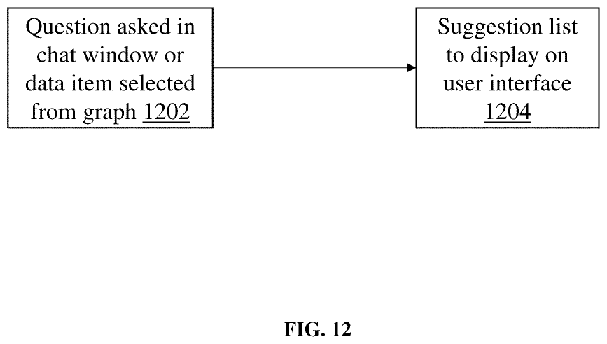

FIG. 12 illustrates example operations in the generation of an output of a method of identifying data connections.

Based on input received from a user, e.g. an analyst via user interface 500 or 550, a suggestion list of data items, e.g. data items based on questions asked in a chat window or data item selected from graph (1202), to be included in a connection analysis prompt for the identification of data items, may be displayed to a user (suggestion list 1204). For example, in the generation of a suggestion list, data items which are similar to a word present in a prompt may lead to the creation of a suggestion in a suggestion list for relations of that data item. For a question “Who is XYZ?” and XYZ may have relations with ABC and PQR, the generated suggestion list may be “Who is ABC” and “Who is PQR”. If no questions have been asked by a user, a suggestion may only include data items of datasets which are known for a customer.

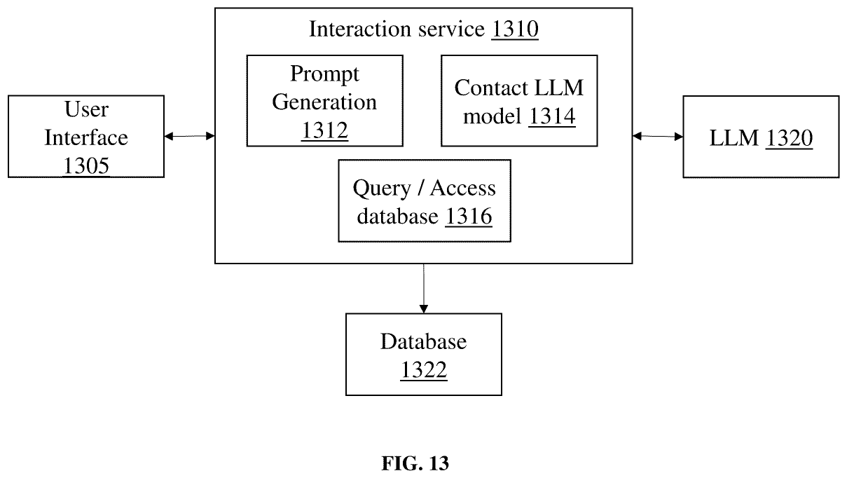

FIG. 13 illustrates operations of an interaction service in the generation of a connection analysis prompt from customer input, e.g. a customer dataset, for the identification of data connections.

The identification of data connections may be initiated via user interface 1305 which is connected to interaction service 1310. Interaction service 1310 may carry out one of the following operations (1312, 1314, 1316): Interaction service 1310 may generate a prompt from data items or datasets of a customer (operation 1312). Interaction service 1310 may apply a prompt to a LLM model 1320 (operation 1314). Interaction service may query a database, e.g. database 1322, for alerts for data items which form part of a connection analysis prompt and have previously recorded for a data item (operation 1316).

Examples of programming code of the interaction service may include: Outlined below is an excerpt of an example connection analysis prompt:

{
“query”: “<prompt to be submitted to LLM model>”
}

An example of a response or output produced or retrieved from an LLM, e.g. LLM 606, may include data items of a link analysis graph 400. An example response from an LLM including alerts may read:

```
{
  “graphData”: {
    “alert1”: { },
    “alert2”: { },
    ...
  }
}
```

Other forms or formats may be used. An example of a response retrieved from an LLM, e.g. LLM 606, may include data items of a link analysis graph 400. An example response from an LLM without produced alerts may read:

{
“summary”: “<LLM model response>”
}

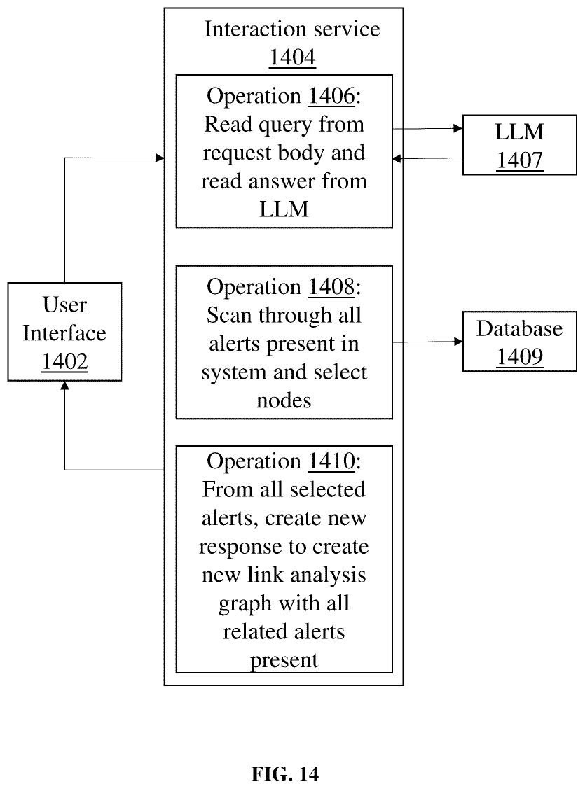

FIG. 14 is a schematic illustration of data flow, referred to as synergistic investigation flow, in a system for identifying data connections.

User interface 1402 may be used to initiate operations such as operations 1406, 1408 or 1410 of an interaction service 1404. In operation 1406, an interaction service 1404 may receive one or more data items of a first dataset, e.g. via user interface 1402. Interaction service 1404 may generate a connection analysis prompt from one or more data items of a first dataset. A generated prompt may be submitted to a ML model, e.g. an LLM 1407.

An example of an excerpt of a connection analysis prompt may read:

{
“query” : Consider this as graph and find all end node
using{LLM_UNDERSTANDABLE_FORMAT}
}

A large language model, e.g. LLM 1407, may apply a connection analysis prompt to identify whether one or more data items of a second dataset.

In response, a ML model, e.g. LLM model 1407, may produce an output of whether one or more data items of a first dataset are connected to one or more data items of a second dataset. In case that one or more data items of the first dataset have one or more connections to one or more data items of a second dataset, an alert may be produced. In case that one or more data items of the first dataset do not have one or more connections to one or more data items of a second dataset, no alert may be produced.

In operation 1408, previously recorded alerts may be analyzed, e.g. to identify previously recorded alerts which include data items or datasets of a connection analysis prompt. For example, databases such as database 1409 may be searched for alerts which include data items or datasets of a connection analysis prompt. For example, a connection analysis prompt may include date items tax number “1234-567” and name “John Smith”, interaction service 1404 may identify whether previously produced alerts stored in database D include data items tax number “1234-567” and name “John Smith”. In case that a previously recorded alert A includes data items tax number “1234-567” and name “John Smith”, alert A may be included in an output.

In operation 1410, data items for which a data connection between two datasets has been identified and produced alerts may be provided to interaction service 1404. Interaction service 1404 may send alerts and data items forming part of a data connection to user interface 1402. In case that no alert has been produced, an interaction service 1402 may provide a user, e.g. an analyst via a user interface with an output “No alert” and/or may return data items/datasets which have been in a previously generated connection analysis prompt.

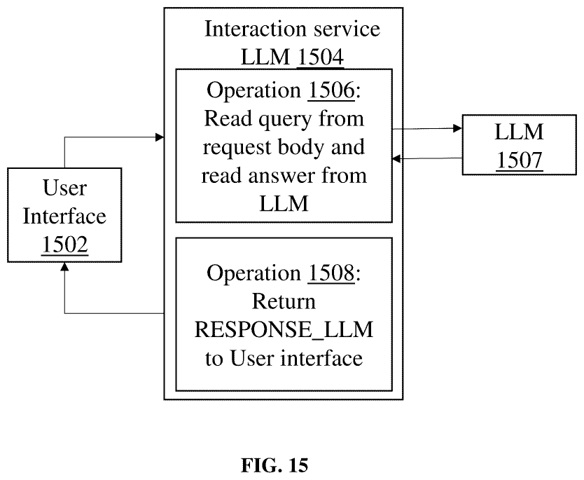

FIG. 15 is a schematic illustration of data flow in a system for identifying data connections.

Once a interaction service 1504 receives a data connection request, e.g. via user interface 1502, interaction service 1504 may carry out one or more of the following operations:

A connection analysis prompt may be submitted to an LLM model (operation 1506).

A connection analysis prompt may read:

{
“query” : $(message typed in chatbox) using
${LLM_UNDERSTANDABLE_FORMAT}
}

In response to a received connection analysis prompt, an LLM model 1507 may generate an output, e.g. in form of a summary of identified connections based on the content of the connection analysis prompt and may provide such an output to interaction service 1504. Output may be displayed to a user via user interface 1502.

An example output of an LLM in form of a summary which is sent to a user interface, e.g. interface 1502, may have the following format (operation 1508):

{
Summary: “<RESONSE_LLM>”
}

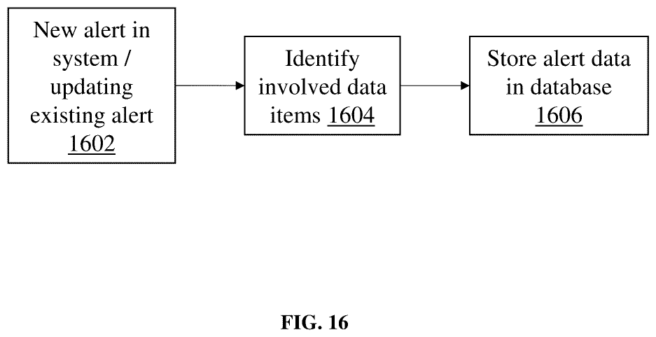

FIG. 16 is a schematic illustration of operations performed to update previously identified data connections when a new dataset is retrieved.

A database, e.g. database 1322 or 1713, may store all produced alerts and its respective connections between data items of datasets which are related to the alert. When an alert is updated, data items linked to an alert may be updated, e.g. a database may be used to produce alerts in subsequent data connection identifications (operation 1602).

Following the production of an alert or updating of an alert, involved data items present in an alert may be identified. For example, data items present in a second dataset which led to the production of an alert after identification of a data connection between a first dataset and the second dataset may be identified, e.g. data items of a second dataset which are not present in a first dataset may be identified (operation 1604). Produced alerts and data items which have been identified, e.g. in a second dataset, may be stored in an alert database (operation 1606).

Table 1 provides a summary of example data types for each of alertID, allNodeInvolvedIds and allNodesInvolved.

Any database can be used based on compatibility with existing solution during implementation. For example, in AWS by Amazon, databases such as “DynamoDB”, “RDS” may be used.

TABLE 1

| Data item | Type [As per NoSQL database] |
|---|---|
| alertID | String |
| allNodeInvolvedIds | String |
| allNodesInvolved | Object |

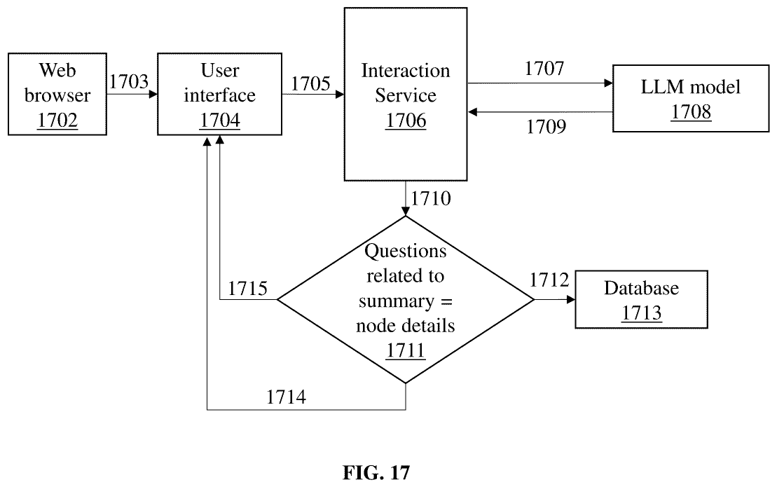

FIG. 17 is a schematic drawing of a system for identifying data connections in a customer facing user interface.

A customer, e.g. using computing device 230, may access user interface 1704 via web browser 1702. Datasets of a user may be retrieved, e.g. in json format, from storage of a user device or storage 204 of computing device 202 and graph 400 may be displayed via user interface 1704 (operation 1705). Interaction service 1706 may automatically generate a connection analysis prompt from data items of a dataset of a customer or may retrieve a request to create a summary of a graph/of a dataset or may answer a question to a specific dataset (operation 1707).

For example, a user, e.g. using computing device 210 may initiate one of the following flows:
Provide as an input a question related to generate summary for a specific dataset related question in “Chat window” of user interface 1704.
Click on “Select data item” button from suggestion list which can give facility to select a data item from graph to receive details specific to that data item.
Initiate “Synergistic investigation” to identify data connections which may identify all data connections and may produce an alert in case that one or more data items have one or more connection to one or more data items of a second dataset.
Review data items of datasets, e.g. to identify details on desired data item, e.g. reviewing an address of a customer X.

For example, flows which may be initiated via user interface 1704 may include:
Generate summary as a fraud desk analyst.
Who is “XYZ” (identification of data item XYZ)·
Generate synergistic investigation.

Example programming code used for executing a flow via interface 1704 may read:

```
  {
    “query” : $(message typed in chatbox) using ${JSON.stringify(submitted
    graphData in JSON format in step-1)}
  }
or
  {
    “query” : $(Consider this as graph and find all end data items using
    ${JSON.stringify(submitted graphData in JSON format in step-1)}
  }
```

Interaction service 1706 may generate a prompt, e.g. a connection analysis prompt and may apply the prompt to a LLM 1708 (operation 1707).

For example, example prompts submitted to an LLM may read:
1) Generate summary as a fraud desk analyst using <LLM_UNDERSTANDBLE_FORMAT>
2) Who is “XYZ” using <LLM_UNDERSTANDBLE_FORMAT>
3) Consider this as a graph and find all end nodes using <LLM_UNDERSTANDBLE_FORMAT>

LLM 1708 may produce an output, e.g. in form of an alert and/or one or more data items or datasets and may provide an output to interaction service 1706 (operation 1709).

Once LLM model 1708 provides an output to interaction service 1706, interaction service 1706 may review a generated output 1710 (operation 1711) in view of the generated prompt. In case that a prompt is a connection analysis prompt, also referred to herein as synergistic investigation, interaction service 1706 may receive an output from an LLM model 1708, e.g. in form of an alert, and may query a database 1713, e.g. database 608, for previously recorded alerts having same data items or datasets present in the connection analysis prompt (operation 1712). Interaction service 1706 may then provide a user interface 1704, e.g. a chat window, with a produced alert and data items for which a data connection has been identified (operation 1714). Interaction service 1706 may further provide a user interface 1704 displayed by web browser 1702 with alerts and an updated analysis graph which may include connections to identified data items and/or alerts for a data items which have been used in the connection analysis prompt.

For example, an ontout 1715 of an LLM may have the format:

{
Summary: “<LLM answer>”
}

For example, an output 1714 of an LLM may have the format:

```
{
  graphData : {
  “alert1” : { },
  “alert2” : { }
  }
}
```

In case that output is a summary of a graph or data item details, interaction service 1706 may send a response including a summary of a graph or data item details to user interface 1704 (operation 1715).

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

What is claimed is:

1. A method of identifying data connections, the method comprising:
generating a connection analysis prompt from one or more data items of a first dataset for identifying one or more data items of a second dataset; and
applying said connection analysis prompt to a machine learning model to produce an output from the machine learning model of whether said one or more data items of the first dataset are connected to said one or more data items of the second dataset; and
when said one or more data items of the first dataset have one or more connections to said one or more data items of a second dataset, producing an alert.

2. A method according to claim 1, wherein said one or more data items of the first dataset comprise a network of customer data items which are linked to a customer dataset.

3. A method according to claim 1, wherein applying said connection analysis prompt comprises identifying data items within said one or more data items of a first dataset which are terminal data items and determining whether said terminal data items are similar to said one or more data items of the second dataset using machine learning.

4. A method according to claim 1, further comprising updating said first dataset based on said connections between said one or more data items of the first dataset and said one or more data items of the second dataset.

5. A method according to claim 1, wherein said machine learning model is a large language model.

6. A method according to claim 1, wherein said one or more data items of the first dataset are extracted from an interaction transcript.

7. A method according to claim 1, wherein said generation of the connection analysis prompt for identifying connections is generated from previously generated connection analysis prompts for identifying connections of said customer.

8. A method according to claim 1, wherein said connection analysis prompt comprises said one or more data items of a first dataset and one or more operators for querying a database comprising said one or more data items of the second dataset.

9. A method according to claim 1, further comprising updating said first dataset when said one or more data items have been linked to said one or more data items of the second dataset.

10. A method according to claim 1, wherein said connections are connections between said one or more data items of the first dataset and data items of a fraud dataset and said connection analysis prompt is applied to a machine learning model to analyze whether said one or more data items of the first dataset have connections to said one or more data items of said fraud dataset.

11. A system for identifying data connections, the system comprising:
a computing device;
a memory; and
a processor, the processor configured to:
generate a connection analysis prompt from one or more data items of a first dataset for identifying one or more data items of a second dataset; and
apply said connection analysis prompt to a machine learning model to produce an output from the machine learning model of whether said one or more data items of the first dataset are connected to said one or more data items of the second dataset; and
when said one or more data items of the first dataset have one or more connections to said one or more data items of a second dataset, to produce an alert.

12. A system according to claim 11, wherein said one or more data items of the first dataset comprise a network of customer data items which are linked to a customer dataset.

13. A system according to claim 11, wherein the processor is configured to apply said connection analysis prompt to identify data items within said one or more data items of a first dataset which are terminal data items and determining whether said terminal data items are similar to said one or more data items of the second dataset using machine learning.

14. A system according to claim 11, wherein the processor is configured to update said first dataset based on said connections between said one or more data items of the first dataset and said one or more data items of the second dataset.

15. A system according to claim 11, wherein the machine learning model is a large language model.

16. A system according to claim 11, wherein said generation of the connection analysis prompt for identifying connections is generated from previously generated connection analysis prompts for identifying connections of said customer.

17. A system according to claim 11, wherein said connection analysis prompt comprises said one or more data items of a first dataset and one or more operators for querying a database comprising said one or more data items of the second dataset.

18. A system according to claim 11, wherein the processor is configured to update said first dataset when said one or more data items have been linked to said one or more data items of the second dataset.

19. A system according to claim 11, wherein said connections are connections between said one or more data items of the first dataset and data items of a fraud dataset and said connection analysis prompt is applied to a machine learning model to analyze whether said one or more data items of the first dataset have connections to said one or more data items of said fraud dataset.

20. A method of automatically identifying fraud in data connections, the method comprising:
generating a fraud detection prompt from a plurality of customer data items for identifying links of said plurality of customer data items to one or more fraud action data items; and
applying said fraud detection prompt to a machine learning model to produce an output from the machine learning model of whether said plurality customer data items is linked to said one or more fraud action data items; and
when said plurality of customer data items is linked to said one or more fraud action data items, creating a fraud notification.
